(19) United States
(12) Patent Application Publication
(10) Pub. No.: US 2008/0185459 A1
(43) Pub. Date: Aug. 7, 2008

(54) Fluid Supply System Used in an Apparatus for Manufacturing Integrated Circuits

(76) Inventors: Doo-Keun An, ChungCheongNam-do (KR); Pyeng-Jae Park, Gwangju Gwangyeok-shi (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 11/792,065

(22) PCT Filed: Dec. 31, 2004
(86) PCT No.: PCT/KR04/03550

§ 371 Date: May 31, 2007

(51) Int. Cl. B05B 1/00

(52) U.S. Cl. 239/267

(57) ABSTRACT

The present invention is directed to a system for supplying chemicals to a plurality of nozzles to fabricate integrated circuits. The system includes a supply line, a return line, and a selecting part for supplying a constant amount of chemicals to the return line or one of nozzles. According to the invention, a constant amount of chemicals are supplied from a chemical storage irrespective of the number of nozzles requiring a supply of chemicals. This enables a pump to avoid overworking and suppresses the conventional problem that a determined time is required for enabling chemicals to reach a fixed temperature.

### TECHNICAL FIELD

The present invention relates to an apparatus for manufacturing semiconductor devices and, more particularly, to a fluid supply system for supplying predetermined fluid to a plurality of apparatuses.

### BACKGROUND ART

Generally, a plurality of layers such as polysilicon, oxide, nitride, and metal are generally formed on a wafer used as a semiconductor substrate during a process of manufacturing semiconductor devices. A photoresist is coated on the layer. A pattern formed on a photo mask using an exposure process is transcribed to the photoresist. In a developing process, the photoresist is selectively removed to form a pattern thereon. Using the photoresist as a mask, an etch process is performed to form the same pattern on the wafer as the pattern formed on the photoresist. An injection nozzle is installed in an etch apparatus where the etch process is performed. Injection nozzles in plural etch apparatuses receive chemicals from one chemical supply system.

FIG. 1 illustrates a conventional chemical supply system 20. The chemical supply system 20 includes a chemical storage 700 and a circular line 710. The circular line 710 has a supply line 712 configured for receiving chemicals from the chemical storage 700 and a return line 714 configured for sending remaining chemicals to the chemical storage 700 after being supplied to nozzles 740. From the circular line 710, a supply pipe branches into supply pipes 720 that are connected to the nozzles 740, respectively. A valve 722 is installed on the respective supply pipes 720 to open and close their paths. A pump 732 and a heater 734 are connected to the supply line 712. The pump 732 supplies a forcible flowing pressure to chemicals flowing along a path of the supply line 712, and the heater 734 heats chemicals. When a process is carried out, a valve 736 installed on the supply pipe 720 is selectively opened and closed to supply chemicals to a valve 740 requiring a supply of chemicals. If one of the valves 722 installed on the supply pipes 720 is opened, a valve 736 installed on the return line 714 is closed.

Unfortunately, the typical chemical supply system 20 has disadvantages, which will be described below. The pump 732 works for supplying a chemical equivalently irrespective of the number of nozzles to which an etchant is supplied, while the amount of a chemical flowing through the supply line 714 is equivalent to the amount of chemicals flowing through a supply pipe 720 whose valve 722 is opened. For this reason, if the valves 722 installed on the supply pipes 720 are partly opened, the pump 732 overworks inevitably to stop its operation. Since the amount of a chemical flowing internally varies with the number of process apparatuses to which an etchant is supplied, the quantity of heat supplied from heater 734 must be regulated to heat the chemical at a fixed temperature used in the process. However, it is not easy to regulate the quantity of the heat. Thus, the temperature of the chemical is apt to deviate from the fixed temperature and lots of time is required for reaching the fixed temperature.

### DISCLOSURE

### Technical Problem

Due to change in number of nozzles requiring a supply of chemicals, the operation of a pump stops and lots of time is required for enabling chemicals to reach a fixed temperature. In order to overcome these problems, the present invention provides a chemical supply system.

### Technical Solution

A fluid supply system according to the present invention includes a circular line and a distributing part. The circular line is connected to a fluid storage and has a supply line and a return line. The distributing part connects the supply line with the return line and has a plurality of selecting sections for supplying a constant amount of fluids, among fluids flowing along the inside of the distributing part, to a nozzle or one of the circular lines.

In an exemplary embodiment, a connection pipe is provided to connect the selecting sections. Each of the selecting sections includes a supply pipe and a return pipe. The supply pipe branches from the connection pipe to be connected to the nozzle and has a valve mounted thereon to open and close a path of the supply pipe. The return pipe branches from the connection pipe to be connected to the return line and has a valve mounted thereon to open and close a path of the return pipe. If one of the valve mounted on the supply pipe and the valve mounted on the return pipe is opened, the other valve is closed. A flow regulating valve may be mounted on the return pipe to regulate a flow rate of fluids flowing along the return pipe.

In another exemplary embodiment, the selecting section includes a selecting pipe, a supply pipe, a return pipe, and a three-way valve. The selecting pipe branches from the supply line or connected to the supply line. The supply pipe branches from the selecting pipe to be connected to the nozzle. The return pipe branches from the selecting pipe to be connected to the return line. The three-way valve is mounted on a branch point of the supply pipe and the return pipe to control a flow direction of fluids flowing along the inside of the three-way valve. A flow regulating valve may be mounted on the respective selecting pipes to regulate a flow rate of fluids flowing along the selecting pipe.

### ADVANTAGEOUS EFFECTS

According to the present invention, the amount of chemicals flowing along a chemical supply line is always constant irrespective of the number of nozzles requiring a supply of the chemicals. This makes it possible to prevent the operation of a pump from stopping due to a differential pressure in a pipe.

Further, the quantity of heat applied from a heater need not be regulated in spite of change in amount of chemicals. This makes it possible to prevent a temperature of the chemicals from deviating from a fixed temperature.

### DESCRIPTION OF DRAWINGS

FIG. 1 illustrates the configuration of a conventional fluid supply system.

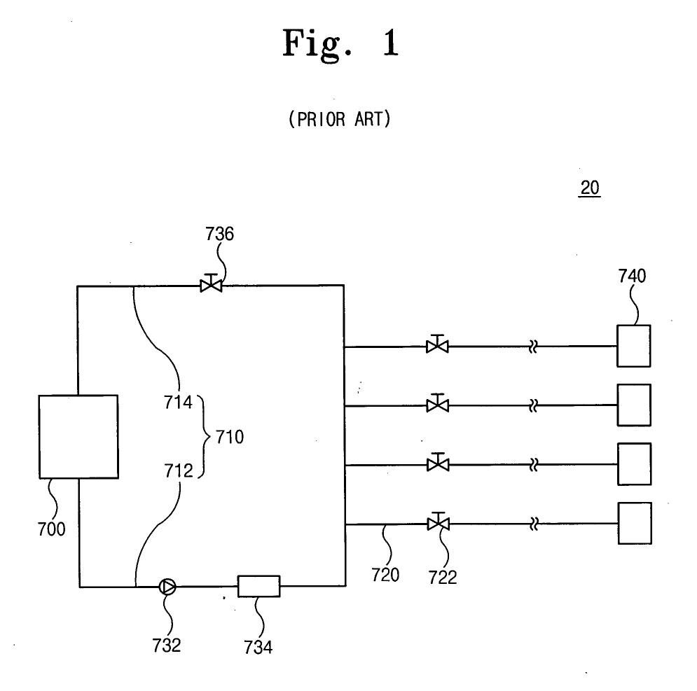

FIG. 2 illustrates a fluid supply system according to the present invention.

FIG. 3 illustrates the configuration of a fluid supply system having a chemical distributing part according to an embodiment of the present invention.

FIG. 4 illustrates an exemplary operation of the fluid supply system illustrated in FIG. 3.

FIG. 5 illustrates the configuration of a fluid supply system having a chemical distributing part according to another embodiment of the present invention.

FIG. 6 illustrates an exemplary operation of the fluid supply system illustrated in FIG. 5.

### BEST MODE

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the height of layers and regions are exaggerated for clarity.

Although systems for supplying chemicals to wafer-etching apparatuses will now be described in exemplary embodiments of the present invention, the invention may be applied to all fluid supply systems for supplying fluids to a plurality of apparatuses. Further, etchants of the embodiments may be different kinds of fluids.

In the exemplary embodiments, nozzles 160 may be installed at process apparatuses, respectively or may be all installed at one process apparatus. Alternatively, a group of nozzles 160 may be installed at a plurality of process apparatuses.

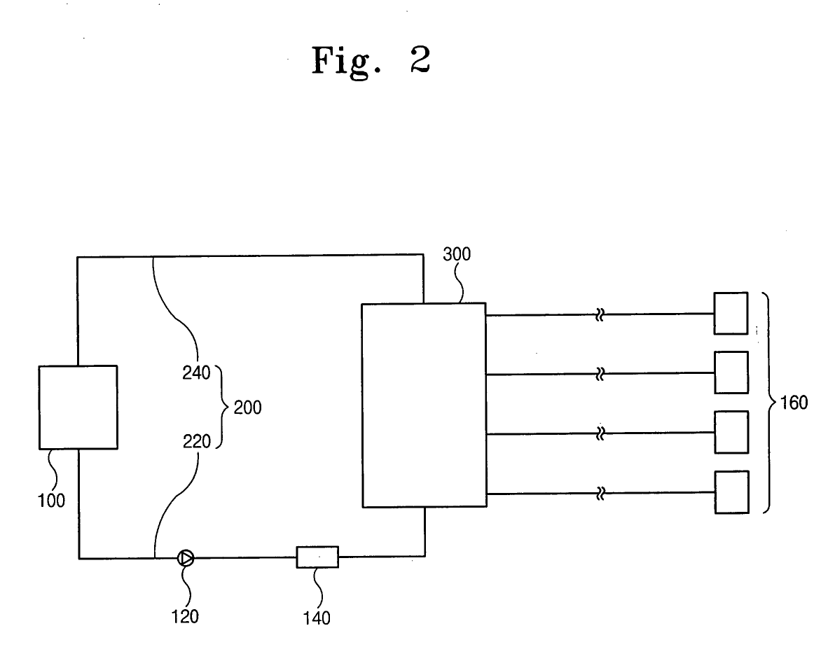

FIG. 2 illustrates a chemical supply system 10 according to the present invention. The chemical supply system 10 includes a chemical storage 100, a circular line 200, and a chemical distributing part 300. The circular line 200 has a supply line 220 and a return line 240. The supply line 220 is a path configured for supplying chemicals from the chemical storage 100, and the return line 240 is a path configured for returning remaining chemicals to the chemical storage after supplying chemicals to a nozzle 160. A pump 120 and a heater 130 are installed at the supply line 120. The pump 120 applies a forcible flowing pressure to chemicals flowing along the inside of the supply line 220, and the heater 140 heats chemicals at a fixed temperature suitable for a process. The chemical distributing part 300 connects the supply line 220 with the return line 240 and distributes chemicals received through the supply line 220 to the nozzle 160. Further, the chemical distributing part 300 enables remaining chemicals to flow to the return line 240.

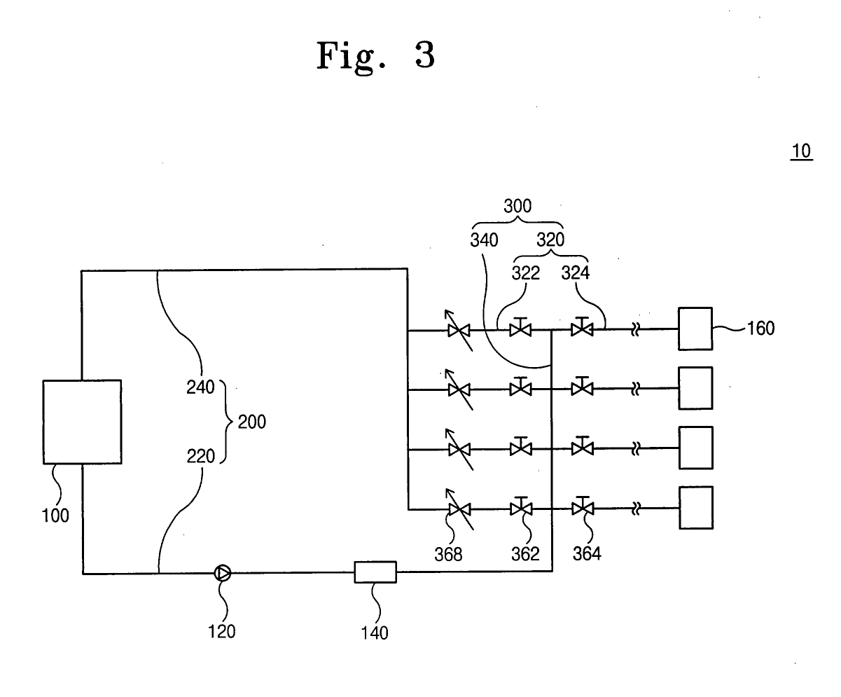

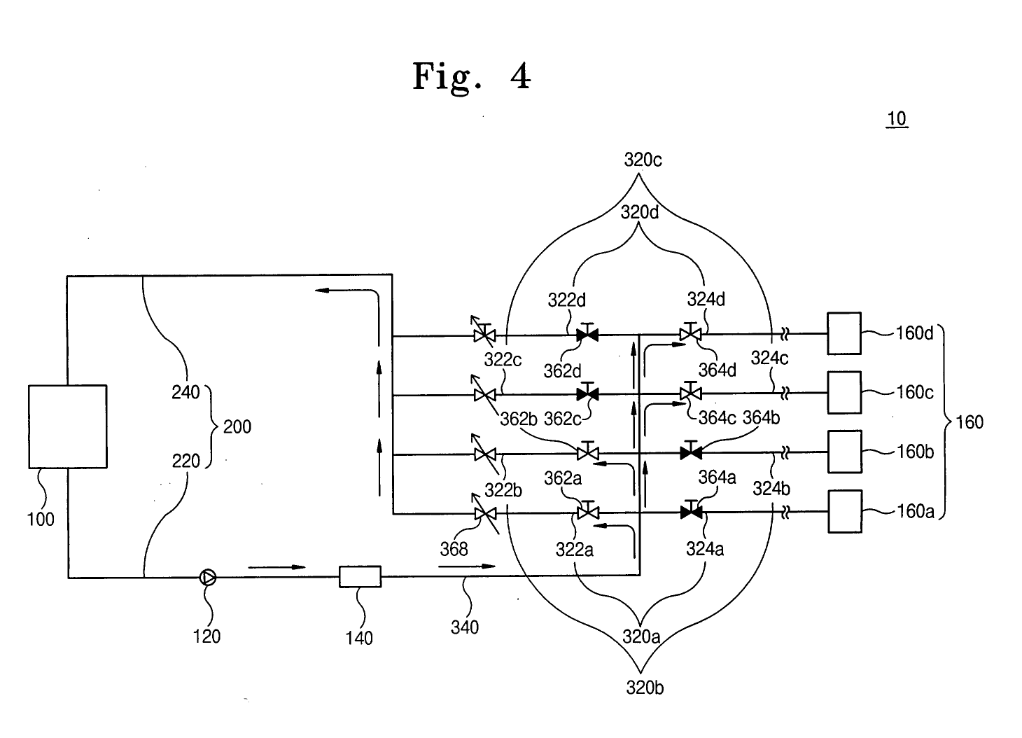

FIG. 3 illustrates a chemical supply system 10 having a chemical distributing part 300 according to an embodiment of the invention. FIG. 4 illustrates an exemplary operation of the chemical supply system 10 illustrated in FIG. 3. Among valves illustrated in FIG. 4, the inside of a closed valve is full while the inside of an opened valve is hollow.

Referring to FIG. 3 and FIG. 4, the chemical distributing part 300 has a connection pipe 340 connecting a supply line 220 with a return line 240 and a plurality of selecting sections 320 for regulating a flow direction of a regular amount of chemicals. The selecting section 320 is configured for selectively distributing chemicals flowing along the connection pipe 340 partly to a nozzle 160 or the return line 240 depending on whether there is a requirement for a chemical supply to the nozzle 160. The connection pipe 340 connects adjacent selecting sections 320. The chemical distributing part 300 has selecting sections 320 of the same number as the nozzles 160.

One of the selecting sections 320 is connected to one nozzle 160 to decide a flow direction of chemicals.

Each of the selecting sections 320 has a supply pipe 324 and a return pipe 322. The supply pipe 324 branches from the connection pipe 340 to be connected to the nozzle 160. The return pipe 322 braches from the connection pipe 340 at the same location as the supply pipe 324 to be connected to the return line 240. Valves 362 and 364 are mounted on each return pipe 324 and supply pipe 322 to open and close its path. The valves 362 and 346 may employ an electrically controllable solenoid valve. A flow regulating valve 368 may be mounted on the respective return pipes 322 to regulate a flow rate of chemicals flowing along their insides. The pump 120 works for supplying chemicals of the same amount as the sum of chemicals supplied to the respective nozzles 160 through the supply line 200. The heater 140 continuously heats chemicals flowing along the inside of the supply line 200 at an equivalent amount of heat. In the respective selecting sections 320, if one of the valves 364 and 362 is opened, the other valve is controlled to be closed. Thus, a constant amount of chemicals supplied to the selecting section 320 always flows to only one of the nozzle 160 and the return line 240.

In this embodiment, chemicals are supplied from the chemical supply system 10 to four nozzles 160. However, the number of nozzles configured for receiving chemicals from the chemical supply system 10 may change variously. For the convenience of the description, the selecting section 320 is divided into a first selecting section 320a, a second selecting section 320b, a third selecting section 320c, and a fourth selecting section 320d that are methodized according to the order adjacent to the supply line 220.

Chemicals supplied to the first selecting section 320a through the supply line 220 are partly supplied to a first nozzle 160a through a first supply pipe 324a or flow to the return line 240 through the first return pipe 322a by handling valves 362a and 364a. The other chemicals supplied to the first selecting section 320a flow to the second selecting section 320b through the connection pipe 340. Chemicals supplied to the second selecting section 320b are partly supplied to a second nozzle 160b through a second supply pipe 324b or flows to the return line 240 through a second return pipe 322b by handling valves 362b and 364b. The other chemicals supplied to the second selecting section 320b are supplied to the third selecting section 320c through the connection pipe 340. Chemicals supplied to the third selecting section 320c are partly supplied to a third nozzle 160c through a third supply pipe 324c or flows to the return line 240 through a third return pipe 322c by handling valves 362c and 364c. The other chemicals supplied to the third selecting section 320a are supplied to the fourth selecting section 320d through the connection pipe 340. All chemicals supplied to the fourth selecting section 320d are supplied to a fourth nozzle 160d through a fourth supply pipe 324d or flows to the return line 240 through a fourth return pipe 322d.

A flow path of chemicals will now be described in detail with reference to FIG. 4. Assuming that during a process, the amount of a chemical supplied from each nozzle 160 is 850 cc/m and a chemical is supplied only to third and fourth nozzles 160c and 160d among first to fourth nozzles 160. A valve 364a mounted on a first supply pipe 324a is closed, and a valve 362a mounted on a first return pipe 322a and a valve 362b mounted on a second return pipe 322b are opened. A valve 324c mounted on a third supply pipe 324c and a valve 364d mounted on a fourth supply pipe 324d are opened, and a valve 362c mounted on a third return pipe 322c and a valve 362d mounted on a fourth return pipe 322d are closed.

A chemical of 3400 cc/m is continuously supplied from a chemical storage 100 through a supply line 220. Among the 3400 cc, 850 cc returns to the chemical storage 100 through the first return pipe 322a and a return line 240, and 2550 cc flows through a connection pipe 340. Among the 2550 cc, 850 cc returns to the chemical storage 100 through the second return pipe 322b and the return line 240, and 1700 cc flows through the connection pipe 340. Among the 1700 cc, 850 cc is supplied to a third nozzle 160c through a third supply pipe 324c, and remaining 850 cc is supplied to a fourth nozzle 160d through a fourth supply pipe 324d after flowing through the connection pipe 340. Although a chemical is equivalently supplied to respective nozzles 160 in this embodiment, the amount of chemicals supplied to the respective nozzles 160 may be different. Diameters of the respective supply pipes 324 are different or a flow regulating valve 368 is handled to regulate the amount of the chemical supplied to the respective nozzles 160.

According to this embodiment, a flow rate of a chemical flowing from the chemical storage 100 to the supply line 220 is constant irrespective of the number of nozzles 160 requiring a supply of chemicals. Therefore, the amount of heat supplied from a heater does not vary with the amount of chemical supplied practically from a supply line, enabling a chemical having a temperature suitable for a process to be supplied to a nozzle. Further, a constant amount of chemical flows along a supply line, making it possible to prevent a pump 140 from being damaged by a differential pressure in a circular line.

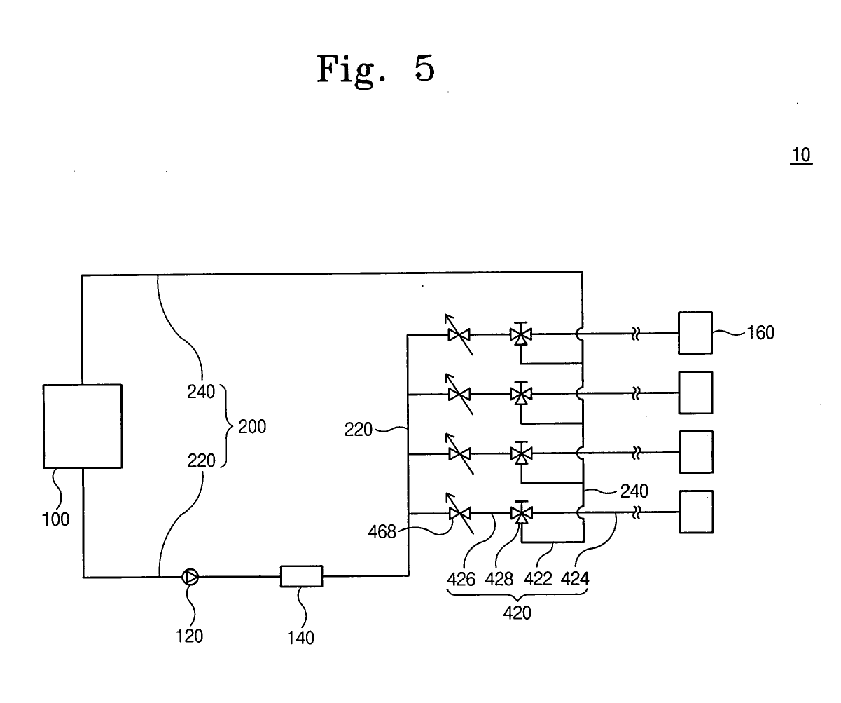

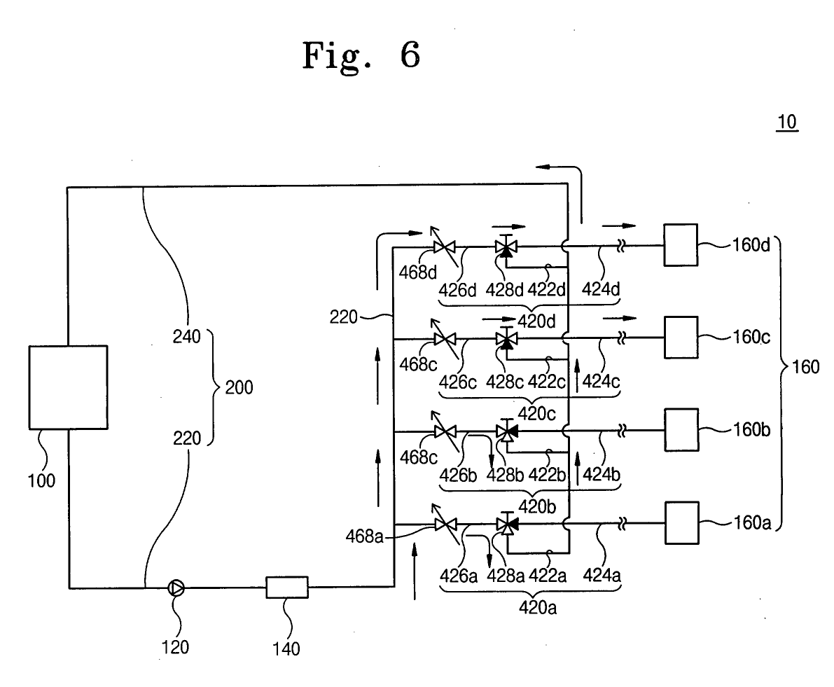

FIG. 5 illustrates a fluid supply system 10 having a chemical distributing part 400 according to another embodiment of the present invention. FIG. 6 illustrates an exemplary operation of the fluid supply system 10 illustrated in FIG. 5. Referring to FIG. 5 and FIG. 6, the fluid supply system 10 includes a chemical storage 100, a circuit line 200 having a supply line 220 and a return line 240, and a chemical distributing part 400. The chemical storage 100 and the circular line 220 are identical to those of the foregoing embodiment and will not be described in further detail. The chemical distributing part 400 has a plurality of selecting sections 420 that branch from the supply line 220 or are connected to the supply line 220. The selecting section 420 supplies chemicals flowing along its path to one of a nozzle 160 or the return line 240. Among the selecting sections, three selecting sections 420a, 420b, and 420c branch from the supply line 220 and the other selecting section 420d are directly connected to the supply line 220. Each of the selecting sections 420 has a distributing pipe 428, a supply pipe 424, a return pipe 422, and a three-way valve 428. The distributing pipe 428 branches from the supply line 220. Chemicals flowing along the distributing pipe 428 flows to one of the supply pipe 424 or the return pipe 422. The three-way valve 428 is mounted on a branch point of the supply pipe 424 and the return pipe 422 to control a flow rate of chemicals. A flow regulating valve 468 may be mounted on the respective distributing pipe 428 to regulate a flow rate of chemicals supplied to the respective nozzles 160.

An inside-full portion of the three-way valve 428 illustrated in FIG. 6 denotes that its path is closed, and an inside-hollow portion thereof denotes that its path is opened. Assuming that among first to fourth nozzles 160 of FIG. 6, the third and fourth nozzles 160c and 160d require a supply of chemicals. A pump 120 works for enabling a constant amount of chemicals to flow to the supply line 220. A heater 140 heats the chemicals at the equivalent amount of heat.

A third flow regulating valve 468c and a fourth flow regulating valve 468d are handled to enable a determined amount of chemicals to be supplied to a third nozzle 120c and a fourth nozzle 120d. A third three-way valve 428c is handled to enable chemicals to flow from the third distributing pipe 426c to a third supply pipe 424c. A fourth three-way valve 428c is handled to enable chemicals to flow from a fourth distributing pipe 426d to a fourth supply pipe 424d. A first flow regulating valve 468a and a second flow regulating valve 468b are handled to enable remaining chemicals, except the chemicals supplied through the third and fourth supply pipes 424c and 424d, to flow to a first distributing pipe 426a and a second distributing pipe 426b. A first three-way valve 428a is handled to enable chemicals to flow from a first distributing pipe 426a to a first return pipe 422a. A second three-way valve 428b is handled to enable chemicals to flow from a second distributing pipe 426b to a second return pipe 422b.

### INDUSTRIAL APPLICABILITY

The present invention can be applied to a variety of apparatuses which requires a system for supply fluids to a plurality of nozzles in a process of fabricating integrated circuits. In spite of change in number of nozzles used, fluids of suitable process condition can be continuously supplied.

What is claimed is:

1. (canceled)

2. A fluid supply system for supplying fluids to a plurality of nozzles to fabricate integrated circuits, comprising:
a circular line having a supply line and a return line, the circular line being connected to a fluid storage; and
a distributing part connecting the supply line with the return line and having a plurality of selecting sections for supplying a constant amount of fluids, among fluids flowing along the inside of the distributing part, to a nozzle or one of the circular lines and a connection pipe connecting the selecting sections,
each of the selecting sections comprising:
a supply pipe branching from the connection pipe to be connected to the nozzle and having a valve mounted thereon to open and close a path of the supply pipe; and
a return pipe branching from the connection pipe to be connected to the return line and having a valve mounted thereon to open and close a path of the return pipe,
wherein if one of the valve mounted on the supply pipe and the valve mounted on the return pipe is opened, the other valve is closed.

3. The fluid supply system of claim 2, wherein each of the selection sections further comprises a flow regulating valve mounted on the return pipe.

4. A fluid supply system for supplying fluids to a plurality of nozzles to fabricate integrated circuits, comprising:
a circular line having a supply line and a return line, the circular line being connected to a fluid storage; and
a distributing part connecting the supply line with the return line and having a plurality of selecting sections for supplying a constant amount of fluids, among fluids flowing along the inside of the distributing part, to a nozzle or one of the circular lines,
wherein the selecting section comprises:
a distributing pipe branching from the supply line or connected to the supply line;
a supply pipe branching from the distributing pipe to be connected to the nozzle;
a return pipe branching from the distributing pipe to be connected to the return line; and
a three-way valve connecting the distributing pipe, the supply pipe, and the return pipe and supplying fluids flowing along the inside of the distributing pipe to the supply pipe or return pipe.

5. The fluid supply system of claim 4, wherein each of the selecting sections further comprises a flow regulating valve mounted on the distributing pipe.

6. The fluid supply system of claim 2, being applied to process apparatuses where an etch process is performed,
wherein the fluids are etchants used in the etch process.
